(19) United States
(12) Patent Application Publication
(10) Pub. No.: US 2009/0145690 A1
(43) Pub. Date: Jun. 11, 2009

(54) High-Rise Aerial Apparatus and Vehicle Equipped Therewith

(75) Inventor: Michel Bruneau, Villiers Sur Marne (FR)

Correspondence Address: ADELI & TOLLEN, LLP, 11940 San Vicente Blvd, Suite 100, LOS ANGELES, CA, 90049, US

(73) Assignee: GIMAEX INTERNATIONAL, Saint Maur Des Fosses (FR)

(21) Appl. No.: 12/332,339

(22) Filed: Dec. 10, 2008

(30) Foreign Application Priority Data
Dec. 11, 2007 (FR) 0708616

(51) Int. Cl. E06C 5/04; E04G 1/24; E06C 1/38; E06C 5/40

(52) U.S. Cl. 182/2.2

(57) ABSTRACT

High-rise aerial apparatus mounted on a vehicle in which off-level correction is required comprises an elongate member particularly an extendable ladder or an optionally telescopic boom extending principally along one axis and able to be equipped with an aerial cage, platform or any type of similar supporting structure. The elongate member is mounted on a base, with an intermediate part interposed between the elongate member and the base, the elongate member being mounted on the intermediate part that pivots about a second axis for off-level correction of the elongate member, the intermediate part being pivotally mounted on the base via a third axis providing for elevation of a free end of the elongate member with respect to the base. Two rams for elevating and lowering the elongate member are pivotally mounted on the base and are each controlled by a controller, and can simultaneously apply off-level correction while elevating the elongate member through suitable control of the rams.

### FIELD OF THE INVENTION

The present invention is related to a high-rise aerial apparatus and to a vehicle equipped therewith.

### BACKGROUND OF THE INVENTION

The present invention relates to high-rise aerial apparatus and to a vehicle equipped to therewith.

High-rise aerial apparatus (or high-rise aerial appliances) as used herein means, firstly, apparatus that includes a ladder. However, this expression should also be taken to mean apparatus of the furniture lift, materials lift or lifting arm type.

High-rise aerial apparatus comprises an elongate member extending principally along one axis and which can typically be an extendable ladder or an optionally telescopic boom. The latter can be equipped with an aerial basket, in other words a cage, a platform or any type of similar supporting structure. The basket can optionally move along the elongate member or, alternatively, be secured to a free end of the elongate member which is designed to be elevated.

In known fashion high-rise aerial appliances also includes a base. The movable elongate member is then pivotally mounted with respect to the base to allow the free end of the member to be raised. The base is further adapted to be secured to a support.

Further, a device for controlling the pivoting of the elongate member that is movable with respect to the base is also provided for raising the free end of the movable elongate member.

In the case of a lifting arm, the elongate member is for example constituted by a first boom section pivotally mounted with respect to a base, so as to allow one end of this first section to be raised with respect to the base. The lift arm may include one or several other sections pivotally mounted one with respect to the others, a basket being secured to the free end of the last section.

Thus, high-rise aerial apparatus in the meaning of the present invention covers apparatus allowing either a person or an object to reach an elevated position above the ground or even a position situated below the level of the support plane of the appliance.

However, the use of such high-rise aerial apparatus can prove difficult or even dangerous when the base thereof is placed on a support that is not level, the degree of inclination or off-level being able to be accentuated at the free end of the elongate member, notably as a function of the elevation and/or extension thereof.

As a way of applying off-level correction to the ladder, applicant's French patent FR 2,631,377 teaches rescue or industrial use apparatus comprising a movable intervention elongate member of considerable length extending principally along a first axis. This member is mounted on a support designed for mounting on a vehicle chassis. The support includes a rotatable orientation turret carrying a pivoting carriage for elevating the member. At one of its ends, the movable intervention member is rotatively mounted on the pivoting carriage about a second axis that is parallel to the axis of the movable intervention member. The second axis is located in a plane that contains the axis of rotation of the turret and is perpendicular to the elevation axis of the carriage. Further, there are provided, in addition to the rams for elevating the movable intervention member, means for bringing about rotation of the movable intervention member about the second axis, so as to re-establish horizontality of the steps—in other words to correct for off-level—of the movable intervention member, of the basket and of any other support member that is integral with the movable intervention elongate member.

However, this apparatus is complex. Further, a certain degree of play is present between the movable intervention member and the carriage which varies with use, meaning that the device shows a certain risk of injury to a user, notably as a result of trapping between the movable intervention member and the carriage. To avoid any risk of injury, protection means are habitually arranged between the carriage and the movable intervention member of such apparatus. The protection means generally take the form of plastic bellow-like members arranged between the carriage and the movable intervention member to avoid anybody or anything getting accidentally trapped between the carriage and the movable intervention member.

Further, German patent application DE 196 53 376 discloses a ladder device comprising a base and a ladder secured to a carriage. The carriage is pivotally mounted with respect to the base on an elevation axis to provide elevation of a free end of the ladder with respect to the base. The base is further mounted pivotally on a support on a horizontal axis that is perpendicular to the axis of elevation. Thus, in the apparatus of DE 196 53 376, correction for ladder off-level is achieved by correcting the off-level of the said base with respect to the support. To achieve this, two rams arranged one at each side of the ladder are provided, each integral with the support and the carriage, extension of the rams being able to be controlled independently.

In the case of this apparatus, the weight that has to be shifted to correct for off-level is considerable consequently requiring significant energy expenditure. If the rams employed are hydraulic, the considerable amount of energy needed for off-level correction in this apparatus is reflected either in the use of significant volumes of hydraulic fluid or by the use of means for boosting hydraulic fluid pressure. In both cases, the apparatus requires complex and bulky arrangements to operate correctly.

Further, this apparatus can be difficult to implement notably in reduced spaces. In effect, compensation for off-level brings about considerable shifting of the ladder and notably the free end thereof.

### SUMMARY OF THE INVENTION

The aim of the present invention is consequently to provide improved high-rise aerial apparatus which notably does not suffer from the disadvantages of known apparatus.

This aim is achieved, in the invention, in high-rise aerial apparatus comprising:

a base,

an elongate member extending principally along a first axis and of which a free end is designed to be elevated,

an intermediate part interposed between the said elongate member and the base, the said elongate member being pivotally mounted on the intermediate part about a second axis for off-level correction of said elongate member, the intermediate part being pivotally mounted on the base, about a third axis providing for elevation of a free end of the said elongate member with respect to the base,

two elevating devices for said elongate member pivotally mounted on said base, and which are integral with said elongate member at each side of said first axis, and

a control device for controlling each one of said elevating devices for said elongate member.

Thus, in the invention, off-level correction of the elongate member is achieved solely by displacing the elongate member about a pivoting axis which is close to the axis of the elongate member itself. For a given off-level correction, the extent to which the elongate member is displaced is considerably reduced when compared to known apparatus in which pivoting of the elongate member takes place about an axis by which the base pivots with respect to the support of the apparatus. The apparatus of the invention is consequently more maneuverable. Also, as a smaller number of parts are getting moved, the weight that gets shifted is also smaller. This leads to the apparatus of the invention having lower energy consumption for a given correction for off-level than apparatus as discussed above.

Further, implementing a control device for each one of the two elevation devices makes it possible to use the elevation devices simultaneously for elevating the elongate member as well as for off-level correction through suitable control of the elevating devices.

According to various embodiments, the high-rise aerial apparatus of the invention can include one or several of the following features either alone or in combination:

the distance between the second axis and the third axis is less than 60 cm and preferably is equal to zero, said distance being measured along a fourth axis contained in the median plane of said high-rise aerial apparatus, perpendicular to the said off-level correction axis and intersecting the said elevation axis;

the distance between the first axis and the second axis is less than 50 cm, preferably less than 30 cm, more preferably less than 20 cm and even more preferably equal to zero, said distance being measured along a fourth axis contained in the median plane of the apparatus, perpendicular to the off-level correction axis and intersecting the elevation axis;

the intermediate part is formed by a carriage, the said elongate member being pivotally mounted with respect to the second axis on the carriage, the carriage being pivotally mounted with respect to the third axis on the base, each one of the two elevating devices being pivotally mounted on the said elongate member;

the elongate member includes a carriage;

each one of the two elevating devices is pivotally mounted on the said elongate member;

each of the two elevating devices is pivotally mounted on the carriage;

each one of the elevating devices of said elongate member is a single-body or dual-body ram;

the elongate member includes a ladder or a boom;

the elongate member supports a basket;

the basket can move with a translatory movement with respect to the elongate member:

the distance between axes of the elevating devices at the elongate member or at the carriage is different from the distance between axes of the elevating devices at the base;

the base includes an orientation turret adapted to be pivotally mounted on a support on a fifth axis perpendicular to the support;

the elevating devices are rams and the control device is adapted to receive information relating to horizontality of said base and elevation of the elongate member with respect to the base, and to control as a consequence a different extension of each one of the two rams in order to correct for off-level of the elongate member;

the elevating devices are hydraulic rams and the control device is adapted to receive information concerning off-level of the elongate member and to control as a consequence thereof transfer of hydraulic fluid from one ram to the other ram in order to correct for off-level of the elongate member.

the second axis is parallel to the first axis.

The invention also provides a vehicle on which the high rise aerial apparatus described above in all combinations thereof is mounted.

Other features and advantages of the invention will become clearer from reading the description which follows of one embodiment of the invention provided solely by way of example and with reference to the attached drawings.

### BRIEF DESCRIPTION OF THE DRAWINGS

FIG. 1 is a rear view of a preferred embodiment of the apparatus.

FIG. 2 is a side view of the apparatus of FIG. 1.

FIGS. 3a and 3b illustrate diagrammatically the principle employed in measuring firstly the distance between the axis of the elongate member and the off-level correction axis and, secondly, the distance between the off-level correction axis and the axis of elevation of the elongate member.

FIG. 4 is a diagrammatic view of a first embodiment of the device for controlling ram extension implemented in the high rise aerial apparatus of FIGS. 1 and 2, and

FIG. 5 illustrates diagrammatically a second embodiment of the ram extension control device implemented in the high rise aerial apparatus of FIGS. 1 and 2.

### DETAILED DESCRIPTION OF PREFERRED EMBODIMENTS

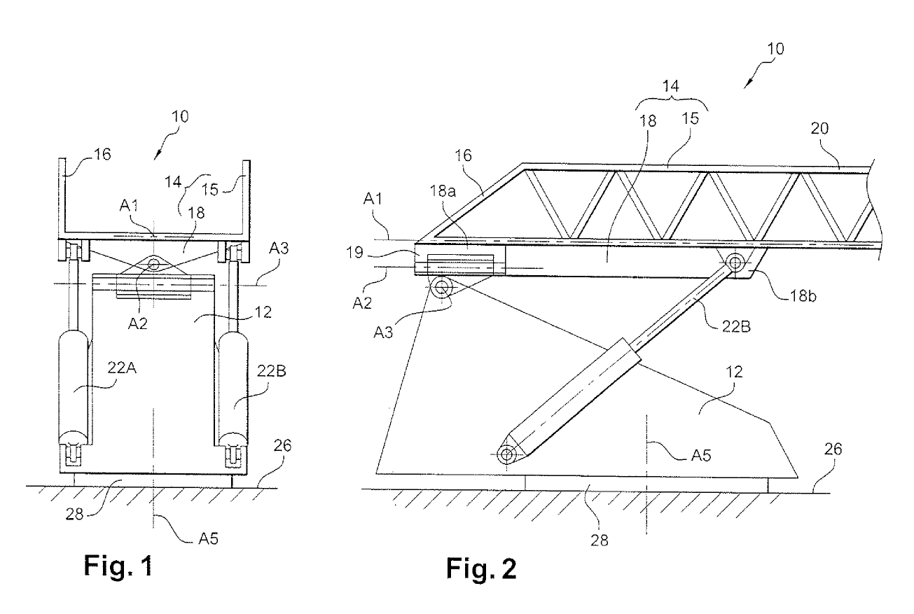

The high rise aerial apparatus 10 as illustrated in FIGS. 1 and 2 comprises a base 12, an elongate member 14 principally extending along a first axis A1. Elongate member 14 comprises in the case under discussion ladder 15 and a carriage 18, the ladder 15 being secured, in the region of its end 16, to carriage 18. In the case under discussion, the first axis A1 (which hereunder we shall call “axis A1 of ladder 15”) is for example, as illustrated in FIGS. 1 and 2, the median axis of the base plan of ladder 15.

Here, carriage 18 is pivotally mounted on an intermediate part 19 interposed between elongate member 14—more precisely carriage 18—and the base 12.

As shown in FIGS. 1 and 2, carriage 18 (and consequently movable elongate member 14) is mounted at one of its ends 18a on the said intermediate part 19 pivoting about a second axis A2 for off-level correction, to allow correction for off-level of elongate member 14.

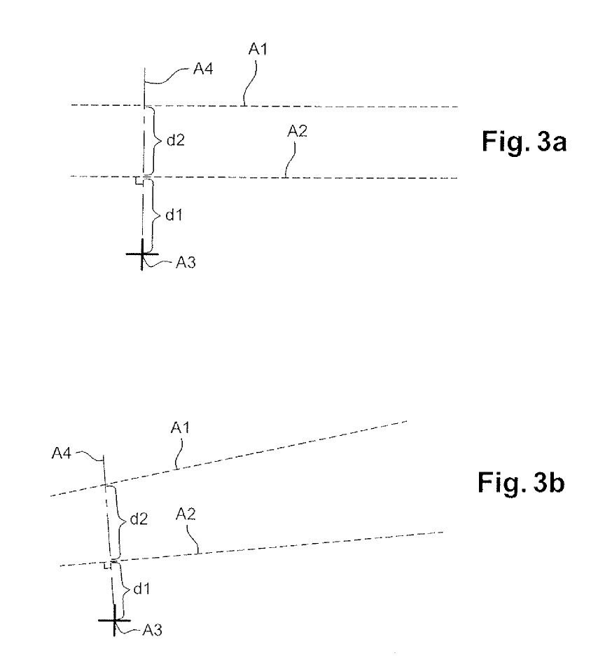

In the case under discussion, off-level correction axis A2 is parallel to axis A1 of ladder 15. Those skilled in the art know however that the off-level correction axis A2 is not necessarily parallel to ladder axis A1 (see notably FIG. 3b). These two axes may notably form an acute angle in the plane of FIG. 2, in other words in the median plane of high rise aerial apparatus 10. Nevertheless, for a given off-level correction, the configurations in which off-level correction axis A2 is parallel to the axis A1 of ladder 15 makes it possible to limit shifting the free end of the ladder resulting from this off-level correction compared to the case where the two axes form an acute angle.

Intermediate part 19 is additionally pivotally mounted on base 12 about a third axis A3 (which we shall call hereinafter “elevation axis A3”) to provide for elevation of the movable elongate member and, thus, the raising of a free end 20 of ladder 15 with respect to base 12.

FIGS. 3a and 3b show diagrammatically two alternatives for the arrangement of ladder axis A1, off-level correction axis A2 and elevation axis A3 of the high rise aerial apparatus of FIGS. 1 and 2, in the median plane of the said apparatus. In FIG. 3a, ladder axis A1 and off-level correction axis A2 are parallel. In contrast, in FIG. 3b, ladder axis A1 and off-level correction axis A2 make an acute angle in the median plane of the high rise aerial apparatus. In both cases however, elevation axis A3 is perpendicular to the median plane of the high rise aerial apparatus and said elevation axis A3 is perpendicular to ladder axis A1 and to off-level correction axis A2.

Referring to FIGS. 3a and 3b, we define a first distance d1 as being the distance between off-level correction axis A2 and elevation axis A3, this distance d1 being measured along a fourth axis A4 contained in the median plane of high rise aerial apparatus 10, perpendicular to off-level correction axis A2 and intersecting elevation axis A3.

Still with reference to FIGS. 3a and 3b, we define a second distance d2 as being the distance between ladder axis A1 and off-level correction axis A2, this second distance d2 being measured along the fourth axis A4 defined above.

High rise aerial apparatus 10 preferably has a distance d1 between off-level correction axis A2 and elevation axis A3 less than 60 cm and more preferably zero. As a result of this reduced distance between off-level correction axis A2 and elevation axis A3, the center of gravity of elongate member 14 is lower when this assembly is in the vehicle running position than is the case in conventional apparatus. Lowering of the center of gravity provides safer driving of the vehicle on which the apparatus is mounted through substantial improvement in stability, notably on roundabouts.

Further, high rise aerial apparatus 10 has, preferably, a distance d2 between ladder axis A1 and off-level correction axis A2 less than 50 cm, more preferably less than 30 cm and even more preferably less than 20 cm and still more preferably equal to zero. In effect, with such a distance d2, displacement of the ladder needed for off-level correction is limited. High rise aerial apparatus 10 is consequently extremely maneuverable and easier and safer to use. Further, a low value for distance d2 also makes it possible to reduce the length of the rams and to reduce their stroke, leading to a gain in weight and a decrease in the amount of hydraulic fluid to supply.

In order to elevate ladder 15, high-rise aerial apparatus 10 of this invention includes two elevation devices, which here consist of two rams 22A, 22B arranged one at each side of carriage 18. Rams 22A, 22B are each integral with base 12 and with carriage 18. In the case under discussion, the rams 22A, 22B are single body hydraulic rams. More precisely, the rams 22A, 22B are here mounted at the end region 18b of carriage 18, at the opposite end to end 18a for raising the end 18b of carriage 18. These rams 22A, 22B are pivotally mounted on elongate member 14 about an axis substantially perpendicular to the plane of FIG. 2.

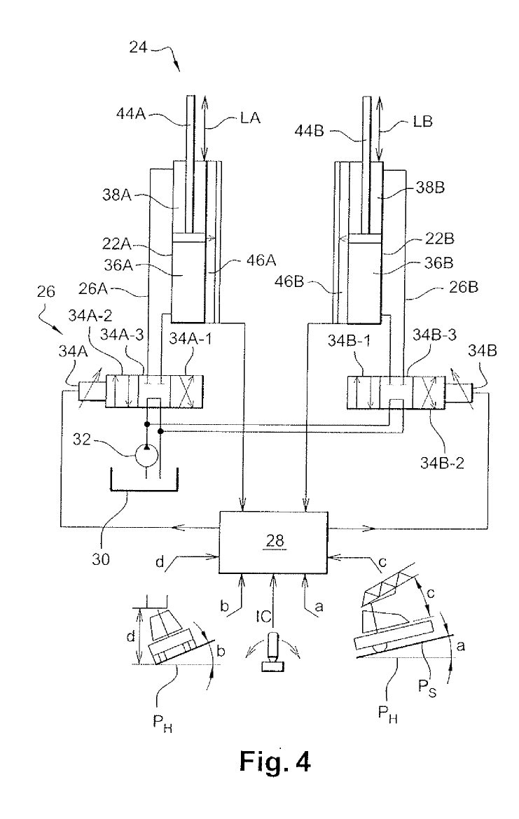

High-rise aerial apparatus 10 also includes a control device for each one of rams 22A, 22B, independently of each other. A first embodiment of this control device 24 is illustrated in FIG. 4. As shown in FIG. 4, control device 24 includes a hydraulic circuit 26 feeding rams 22A, 22B and an electronic control unit 28. Control device 24 is supplied with hydraulic fluid—conventionally oil—from a tank 30 by means of a pump 32 for causing hydraulic fluid to circulate in hydraulic circuit 26. Hydraulic circuit 26 has two identical branches 26A, 26B each associated with one of the two rams 22A, 22B. These two branches 26A, 26B are arranged in parallel, downstream of pump 32. A solenoid valve 34A, 34B controlled by electronic control unit 28 is arranged in each of the branches 26A, 26B. In the case under discussion, the solenoid valves 34A, 34B have four ports and three operating positions.

In a first position 34A-1, 34B-1 of solenoid valves 34A, 34B, the elevation chambers 36A, 36B of rams 22A, 22B are supplied with hydraulic fluid by pump 32, while lowering chambers 38A, 38B of rams 22A, 22B are in fluid communication with tank 30.

In a second position 34A-2, 34B-2 of solenoid valves 34A, 34B, lowering chambers 38A, 38B of rams 22A, 22B are supplied with hydraulic fluid by pump 32 while lowering chambers 36A, 36B of rams 22A, 22B are in fluid communication with tank 30.

Finally, in a third position 34A-3, 34B-3 of solenoid valves 34A, 34B, fluid communication between tank 30 and, firstly, elevation chambers 36A, 36B and, secondly, lowering chambers 38A, 38B is broken off.

The position of the two solenoid valves 34A, 34B can be controlled independently of each other. Notably, it is possible to control elevation of one ram (corresponding to supplying the elevation chamber of one of the rams with hydraulic fluid) while controlling the lowering of the other ram (corresponding to supplying the lowering chamber of the other ram with hydraulic fluid).

Referring now to FIGS. 1 and 2, the base of high-rise aerial apparatus 10 in the case under discussion is composed of an orientation turret 12 adapted to be pivotally mounted on a support 26 on a fifth axis A5 (hereinafter the “orientation axis”) perpendicular to the support 26. This is achieved by turret 12 being mounted on an orientation crown 28 integral with support 26. In the case here, support 26 of turret 12 is mounted on a vehicle.

Here, vehicle 10 is a truck type automobile vehicle, but obviously this vehicle can be of any other type, such as a utility type automobile vehicle or even a non-powered vehicle such as for example a trailer.

The operation of high-rise aerial device 10 according to the invention derives from the structural description just discussed.

Thus, high-rise aerial apparatus 10 has three degrees of freedom to allow the free end 20 of ladder 15 to reach any point in the space located at a distance from apparatus 10 less than the length of ladder 15. These three degrees of freedom are:

rotary movement of orientation turret 12 about orientation axis A5;

elevational movement of ladder 15 by rotation about elevation axis A3; and

translatory movement of the free end 20 of movable ladder 15 parallel to the axis A1 of ladder 15; this movement is in the case under discussion a result of the fact that ladder 15 is telescopic.

High-rise aerial device 10 has an additional fourth degree of freedom since carriage 18 can tilt about off-level correction axis A2.

Consequently, to reach any given point, the operator controls or adjusts rotation of turret 12 about orientation axis A5, elevation of ladder 15 by making ladder 15 pivot about elevation axis A3, and extension of ladder 15. These three movements can be performed simultaneously, successively or, yet again, in successive sequences.

However, where the support 26 on which orientation crown 28 is mounted is not horizontal but on the contrary exhibits a degree of off-level, this off-level will possibly be experienced in an accentuated fashion at ladder 15. In this case, ladder 15 may become dangerous to use or even unusable.

In order to correct for off-level simultaneously with adjustment of the position of ladder 15, control device 24 provides to supply hydraulic fluid to the rams independently one of the other, which makes it possible to simultaneously tilt ladder 15 about elevation axis A3 and about off-level correction axis A2, for correcting for off-level of ladder 15.

In the embodiment of control device 24 shown in FIG. 4, this is achieved by electronic control unit 28 receiving the following information from suitable sensors:

the angle b of off-level of base 12 with respect to a horizontal plane P_{H}, measured in the transverse plane of the support of high-rise aerial apparatus 10;

the angle d of off-level at ladder 15, off-level being measured with respect to horizontal plane P_{H};

elevation angle c of ladder 15 measured between carriage 18 or ladder 15 and base 12 mounted on a vehicle;

the angle a of slope measured, in the longitudinal plane of the high-rise aerial apparatus, between plane P_{S} on which the vehicle on which base 12 is mounted is resting, and horizontal plane P_{H}; and

the length LA, LB of the rod 44A, 44B of each ram 22A, 22B that extends outside the ram, these lengths being measured by means of position sensors 46A, 46B.

The various angles are measured by angle sensors which are well known to those skilled in the art.

Electronic control unit 28 also receives a signal IC to control elevation or lowering and/or left or right rotation, as commanded by the operator.

Using this information, and more particularly ladder 15 elevation angle c and operator command IC to elevate or lower it, electronic control unit 28 establishes a reference setpoint for a length LR for piston rods 44A, 44B of rams 22A, 22B which should be deployed.

However, this setpoint is modulated for each ram in order to correct for off-level of elongate member 15 so that, at any given point in time, the following relations hold:

LR=(LA+LB)/2

d=0.

In one advantageous embodiment, setpoint modulation is mapped in the electronic control unit as a function of angles a, b, c and reference length LR.

In order to follow the instructions that are effective, electronic control unit 18 alternatively or simultaneously controls solenoid valves 34A, 34B in order to control supply to elevation chambers 36A, 36B and/or or lowering chambers 38A, 38B of one ram 22A, 22B independently of the other ram 22B, 22A.

In order to adjust the length of ladder 15, it suffices to control deployment of the telescopic elements of ladder 15.

However, in the case of high-rise aerial apparatus 10, only carriage 18 and ladder 15 are displaced to correct for off-level. In effect, the off-level correction axis A2 about which ladder 15 tilts to compensate for off-level is close to the axis A1 of ladder 15. Thanks to this, when correcting for off-level, angular displacement of ladder 15 is reduced. A given off-level correction is consequently reflected in a less significant displacement than would be the case where ladder 15 had to tilt about an axis located further away from its own axis. The amount of energy needed to correct for off-level is consequently smaller than in the case of known high-rise aerial apparatus in which the base is also displaced. Further, this correction is less dangerous in view of the smaller amplitude of displacement necessary for off-level correction.

Further, when ladder 15 can move by turning with respect to carriage 18, movements of the ladder can be dangerous. In this case, protective measures such as bellow-like protectors need to be provided additionally between ladder 15 and carriage 18.

However, in the high-rise aerial apparatus 10, the ladder 15 is secured in integral fashion to carriage 18. There is consequently no need for protective members to be fitted between ladder 15 and carriage 18. High-rise aerial apparatus 10 is consequently both safer and less expensive to produce.

Ladder 15, secured in integral fashion to carriage 18, further shows greater rigidity against twisting.

Additionally, the fact of using the same single body rams for elevating ladder 15 and for of-level correction, the hydraulic circuit for controlling the rams 22A, 22B can be simplified. Thus, the circuit can include three levels of hydraulic spool valve instead of the four levels in known apparatus. Also, many of the hydraulic lines and flexible pipes required in state-of-the-art apparatus are no longer necessary. This results in reduced supply costs and assembly costs for the high-rise aerial apparatus compared to known apparatus. A reduction in weight is also achieved, if not simply by the reduction in the number of rams.

The invention is obviously not limited to the embodiment that has just been described by way of example and numerous variations are possible without departing from the scope of the invention.

Thus, the various movements can be performed either successively (in other words consisting of sequential movements) and in any order whatsoever, or simultaneously (in other words combined movements), or as a combination of sequential and successive combined movements.

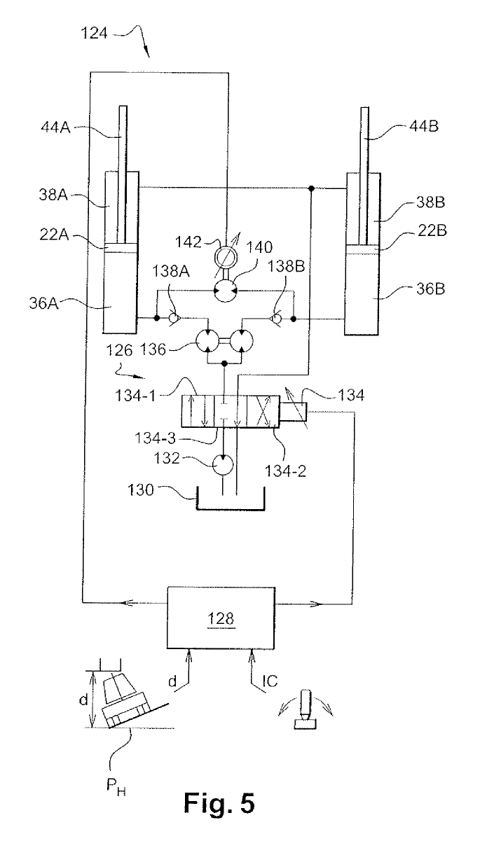

Further, one alternative embodiment 124 of the control device for each of the rams is shown in FIG. 5.

As illustrated in FIG. 5, control device 124 includes a hydraulic circuit 126 for driving rams 22A, 22B and an electronic control unit 128. The control device 124 is supplied with hydraulic fluid from a tank 130 via a pump 132 for driving hydraulic fluid through hydraulic circuit 126. Downstream of pump 132, hydraulic circuit 126 includes a solenoid valve 134 controlled by electronic control unit 128. In the case being discussed, solenoid valve 134 has four ports and three operating positions.

In a first position 134-1 of solenoid valve 134, the elevation chambers 36A, 36B of rams 22A, 22B are supplied with hydraulic fluid by pump 132 while lowering chambers 38A, 38B of the rams 22A, 22B are in fluidic communication with tank 130.

In a second position 134-2 of solenoid valve 134, lowering chambers 38A, 38B of rams 22A, 22B are supplied with hydraulic fluid from pump 132, while elevation chambers 36A, 36B of rams 22A, 22B are in fluidic communication with tank 130.

Finally, in a third position 134-3 of solenoid valve 134, fluidic communication between tank 130 and elevation chambers 36A, 36B is shut off while lowering chambers 38A, 38B are in fluidic communication with tank 130.

Downstream of solenoid valve 134 and upstream of elevation chambers 36A, 36B, a flow splitter 136 is arranged in hydraulic circuit 126. Such flow splitter 136 ensures equal supply of hydraulic fluid to elevation chambers 36A, 36B. Thus, the amount of hydraulic fluid feeding respectively each one of ram chambers 22A, 22B originating from flow splitter 136 is, at any given moment in time, the same.

Further, a nonreturn valve 138A, 138B is inserted in hydraulic circuit 126 between each one of the elevation chambers 36A, 36B and flow splitter 136. In the embodiment illustrated of the control device, these nonreturn valves 138A, 138B are controlled selectively to ensure drainage of elevation chambers 36A, 36B notably when the rams 22A, 22B are in the process of being lowered.

Control device 124, in this second embodiment, further includes a fluid transfer device 140 for selectively transferring a quantity of hydraulic fluid from one of the two elevation chambers 36A, 36B to the other elevation chamber 36B, 36A. Thus, this fluid transfer device 140 operates on the principle of a pump which draws in an amount of hydraulic fluid from one elevation chamber 36A, 36B and transfers this amount of hydraulic fluid to the other elevation chamber 36B, 36A. This transfer device 140 can, as illustrated in FIG. 5, be operated by an electric motor 142 controlled by electronic control unit 128.

In a further embodiment not illustrated, the fluid transfer device can be operated by a hydraulic motor fed with hydraulic fluid from the tank via the pump. Supply of hydraulic fluid to the hydraulic motor can then be controlled by the electronic control unit, via a solenoid valve.

With this alternative embodiment of control device 124, electronic control unit 128 only requires an angle of off-level d to be measured, example, on a ladder step 15. Depending on the sign and value of this off-level angle d, electronic control unit 128 controls transfer of hydraulic fluid from one of the elevation chambers 36A, 36B to the other elevation chamber 36B, 36A by means of fluid transfer device 140 so as to correct for off-level, in other words up until the point where d=0 (or, in any case, until such point as d is less than a predetermined limiting value). This correction can be implemented subsequently to deployment and positioning of the ladder or, as it is preferable, simultaneously with these actions.

Further, according to an embodiment not illustrated of the high-rise aerial apparatus, the rams are dual body rams. In this case, a first body can for example be implemented for elevating the ladder and a second body, which will be smaller in size than the first body, can be implemented solely for off-level correction. In this case, the two bodies of the rams can be fed by separate hydraulic circuits.

Further, the rams 22A, 22B which in FIG. 2 are illustrated as being parallel, can alternatively be inclined one with respect to the other. In other words, the distance between centers of rams 22A, 22B at the carriage 18 or at the ladder 15 (depending on to which one the rams are secured) is different from—in particular less than—the distance between centers of the rams 22A, 22B at the base 12. This arrangement makes for better stability of the high-rise aerial apparatus 10 and, more particularly, of ladder 15. In effect, in this case, a force component which is parallel to the base appears, this force component notably preventing lateral deviation of ladder 15.

Further, in an alternative embodiment, the ladder can pivot about the off-level correction axis with respect to the carriage. In this case, the elevating devices are secured to the ladder. Even in this case, the distances d1 and d2 between, firstly, the ladder axis and the off-level correction axis and, secondly, the off-level correction axis and elevation axis are preferably comprised within the ranges given previously, to ensure proximity of the various axes.

In a further alternative embodiment, in which the ladder is integrally secured to the carriage and the carriage is pivotally mounted about an elevation axis on an intermediate part interposed between the elongate member and the base, the intermediate part is mounted on the base pivotally about an off-level correction axis. In this embodiment, the intermediate part is also shifted for off-level correction. This embodiment is consequently slightly less advantageous than the one discussed with reference to FIG. 1 and FIG. 2. Nevertheless, in this embodiment as well, the elevating devices for the elongate member are employed for correcting the off-level of this elongate member and the distance between the off-level correction axis and the ladder axis (or more generally, the axis of the movable elongate member) is also limited in order to thereby limit, firstly, the weight required to be shifted to achieve such off-level correction and, secondly, the degree of movement of the ladder required for off-level correction. Thus, even in this embodiment, it is useful to maintain the distances d1, d2 between firstly, the ladder axis and the off-level correction axis and, secondly, the off-level correction axis and the elevation axis comprised within the ranges given above to ensure proximity of the various axes.

Further, as shown in FIG. 1 and FIG. 2, the movable elongate member 15 is a ladder. However, according to alternative embodiments of the high-rise aerial apparatus 10, this elongate member can also be constituted by an arm or boom adapted to carry a basket such as a cage or platform, the basket being additionally able to undergo translatory movement with respect to the boom. Thus, the invention finds advantageous application is in apparatus such as those for lifting in furniture removal or for lifting materials, apparatus known as “cherry pickers” or the like.

The invention also finds application in the case of a lifting arm such as described above. In effect, it is known to correct for off-level of the basket supported by the final section of such a lifting arm at the connection between the basket and this final section. However, the invention makes it possible to correct the inclination of the basket by correcting the inclination of the initial section of the arm, which is mounted on the base, via an intermediate part which can pivot about two perpendicular axes to allow, firstly, elevation of the first section of the arm and, secondly, the correction for off-level of the said initial section.

1. A high-rise aerial apparatus comprising:
a base,
an elongate member extending principally along a first axis and of which a free end is designed to be elevated,
an intermediate part interposed between the said elongate member and the base, the said elongate member being pivotally mounted on the intermediate part about a second axis for off-level correction of said elongate member, the intermediate part being pivotally mounted on the base, about a third axis providing for elevation of a free end of the said elongate member with respect to the base,
two elevating devices for said elongate member pivotally mounted on said base, and which are integral with said elongate member at each side of said first axis, and
a control device for controlling each one of said elevating devices for said elongate member.

2. The apparatus according to claim 1, in which a distance between the second axis and the third axis is less than 60 cm and preferably is equal to zero, said distance being measured along a fourth axis contained in the median plane of said high-rise aerial apparatus, perpendicular to the said off-level correction axis and intersecting the said elevation axis.

3. The apparatus according to claim 1, in which a distance between the first axis and the second axis is less than 50 cm, preferably less than 30 cm, more preferably less than 20 cm and even more preferably equal to zero, said distance being measured along a fourth axis contained in the median plane of the apparatus, perpendicular to the off-level correction axis and intersecting the elevation axis.

4. The apparatus according to claim 1, in which said intermediate part is formed by a carriage, the said elongate member being pivotally mounted with respect to the second axis on the carriage, the carriage being pivotally mounted with respect to the third axis on the base, each one of the two elevating devices being pivotally mounted on the said elongate member.

5. The apparatus according to claim 1, in which the said elongate member includes a carriage.

6. The apparatus according to claim 1, in which each one of the two elevating devices is pivotally mounted on the said elongate member.

7. The apparatus according to claim 5, in which each of the two elevating devices is pivotally mounted on the carriage.

8. The apparatus according to claim 1, in which each one of the elevating devices of said elongate member is a single-body or dual-body ram.

9. The apparatus according to claim 1, in which the elongate member includes a ladder or a boom.

10. The apparatus according to claim 1, in which the elongate member supports a basket.

11. The apparatus according to claim 10, in which the basket can move with a translatory movement with respect to the elongate member.

12. The apparatus according to claim 1, in which a distance between axes of the elevating devices at the elongate member or at the carriage is different from a distance between axes of the elevating devices at the said base.

13. The apparatus according to claim 1, in which the base includes an orientation turret adapted to be pivotally mounted on a support about a fifth axis perpendicular to the support.

14. The apparatus according to claim 1, in which the elevating devices are rams and in which the control device is adapted to receive information relating to horizontality of said base and elevation of the elongate member with respect to the base, and to control as a consequence a different extension of each one of the two rams in order to correct for off-level of the movable elongate member.

15. The apparatus according to claim 1, in which the elevating devices are hydraulic rams and in which the control device is adapted to receive information concerning off-level of said elongate member and to control as a consequence thereof transfer of hydraulic fluid from one ram to the other ram in order to correct for off-level of the movable elongate member.

16. The apparatus according to claim 1, in which the second axis is parallel to the first axis.

17. A vehicle having mounted thereon high-rise aerial apparatus comprising:
a base,
an elongate member extending principally along a first axis and of which a free end is designed to be elevated,
an intermediate part interposed between the said elongate member and the base, the said elongate member being pivotally mounted on the intermediate about a second axis for off-level correction of said elongate member, the intermediate part being pivotally mounted on the base, about a third axis providing for elevation of a free end of the said elongate member with respect to the base,
two elevating devices for said elongate member pivotally mounted on said base, and which are integral with said elongate member at each side of said first axis, and
a control device for controlling each one of said elevating devices for said elongate member.

18. A high-rise aerial apparatus comprising:
a base,
an elongate member extending principally along a first axis and of which a free end is designed to be elevated,
an intermediate part interposed between the said elongate member and the base, the said elongate member being mounted on the intermediate part that pivots about a second axis providing for elevation of a free end of the said elongate member with respect to the base, the intermediate part being pivotally mounted on the base, about a third axis for off-level correction of said elongate member,
two elevating devices for said elongate member pivotally mounted on said base, and which are integral with said elongate member at each side of said first axis, and
a control device for controlling each one of said elevating devices for said elongate member.

19. The apparatus according to claim 18, in which a distance between the second axis and the third axis is less than 60 cm and preferably is equal to zero, said distance being measured along a fourth axis contained in the median plane of said high-rise aerial apparatus, perpendicular to the said off-level correction axis and intersecting the said elevation axis.

20. The apparatus according to claim 18, in which a distance between the first axis and the second axis is less than 50 cm, preferably less than 30 cm, more preferably less than 20 cm and even more preferably equal to zero, said distance being measured along a fourth axis contained in the median plane of the apparatus, perpendicular to the off-level correction axis and intersecting the elevation axis.

21. The apparatus according to claim 18, in which the said elongate member includes at least one of a carriage, a ladder and a boom.
